(19) United States
(12) Patent Application Publication
(10) Pub. No.: US 2024/0423217 A1
(43) Pub. Date: Dec. 26, 2024

(54) DOUBLE-HOOK DOUGH KNEADING STRUCTURE AND DOUGH MIXER

(71) Applicant: BAINNIDA TECH CO.,LTD, Shenzhen (CN)

(72) Inventor: Chuang LI, Shenzhen (CN)

(73) Assignee: BAINNIDA TECH CO.,LTD, Shenzhen (CN)

(21) Appl. No.: 18/747,548

(22) Filed: Jun. 19, 2024

(30) Foreign Application Priority Data
Jun. 20, 2023 (CN) 202321575180.7

(51) Int. Cl. A21C 1/14

(52) U.S. Cl. CPC A21C 1/1405

(57) ABSTRACT

The present invention relates to a double-hook dough kneading structure, it includes an output shaft, a rotating rod with a center perpendicularly fixed to a bottom of the output shaft, a first rotating shaft rotationally connected to one end of the rotating rod, a second rotating shaft rotationally connected to the other end of the rotating rod, a first dough kneading hook detachably connected to a bottom of the first rotating shaft, a second dough kneading hook detachably connected to a bottom of the second rotating shaft, an internally-toothed ring fixed to an outer side of the output shaft, a first planetary gear fixed to a top of the first rotating shaft, and a second planetary gear fixed to a top of the second rotating shaft, where the first planetary gear and the second planetary gear are respectively engaged with an inner side of the internally-toothed ring.

### CROSS-REFERENCE TO RELATED APPLICATIONS

The application claims priority to Chinese patent application No. 202321575180.7, filed on Jun. 20, 2023, the entire contents of which are incorporated herein by reference.

### TECHNICAL FIELD

The present invention relates to the technical field of dough mixers, in particular to a double-hook dough kneading structure and a dough mixer.

### BACKGROUND

Household food processing tools include an automatic dough kneading machine, which contain flour and water in a mixing pot. A dough kneading hook is arranged in the mixing pot, the dough kneading hook is driven by a driving device to rotate in the mixing pot so as to mix the water and the flour and perform the dough kneading action, and the manual dough kneading operation is replaced, so that the machine is time-saving, labor-saving, convenient and sanitary. However, in the kneading process of the flour, an existing dough mixer uses a single dough kneading hook to complete the dough kneading work. In the use process, dough usually moves with the dough kneading hook, so that the dough kneading efficiency is low, and the effect is not ideal enough. In addition, under the action of an unbalanced force of the single dough kneading hook, the entire mixer has the great vibration and shaking amplitude.

The Chinese invention patent with the application number 201110264424.5 discloses a dough kneading hook structure, including a first dough kneading hook, where a top of the first dough kneading hook is mounted on a first drive structure; and further including a second dough kneading hook, where a top of the second dough kneading hook is connected to a second drive structure; the first drive structure and the second drive structure are respectively a first planetary gear and a second planetary gear; the first planetary gear and the second planetary gear are connected to a sun gear; a rotating spindle is fixed in the sun gear; and each of the first planetary gear and the second planetary gear includes a gear portion and a gear shaft arranged below the gear portion.

An existing double-hook structure basically uses a sun gear to drive two planetary gears to rotate, thereby driving two dough kneading hooks to rotate. However, according to the structure, when the autorotation speeds of the dough kneading hooks need to be changed, the tooth numbers of the two planetary gears need to be adjusted, the tooth number of the sun gear also needs to be adjusted. Therefore, it is difficult to change the autorotation speeds of the dough kneading hooks, and the problems such as gear faults appear easily due to excessive gear components.

### SUMMARY

In order to overcome the defects and shortcomings in the prior art, the present invention aims to provide a double-hook dough kneading structure and a dough mixer.

The purpose of the present invention is achieved by means of the following technical solution: the double-hook dough kneading structure comprises an output shaft, a rotating rod with a center perpendicularly fixed to a bottom of the output shaft, a first rotating shaft rotationally connected to one end of the rotating rod, a second rotating shaft rotationally connected to the other end of the rotating rod, a first dough kneading hook detachably connected to a bottom of the first rotating shaft, a second dough kneading hook detachably connected to a bottom of the second rotating shaft, an internally-toothed ring fixed to an outer side of the output shaft, a first planetary gear fixed to a top of the first rotating shaft, and a second planetary gear fixed to a top of the second rotating shaft, where the first planetary gear and the second planetary gear are respectively engaged with an inner side of the internally-toothed ring.

Further, the first dough kneading hook comprises a first connection portion detachably connected to the bottom of the first rotating shaft and a first mixing portion fixed to a bottom of the first connection portion, and the first mixing portion is of a single-spiral structure.

Further, the second dough kneading hook comprises a second connection portion detachably connected to the bottom of the second rotating shaft and a second mixing portion fixed to a bottom of the second connection portion, and the second mixing portion is of a single-spiral structure.

Further, the size of the first dough kneading hook is greater than the size of the second dough kneading hook.

Further, a first rotating base is fixed to a bottom of one end of the rotating rod, a second rotating base is fixed to a bottom of the other end of the rotating rod, the first rotating shaft is rotationally connected into the first rotating base, and the second rotating shaft is rotationally connected into the second rotating base.

Further, bearings are embedded in tops and bottoms of the first rotating base and the second rotating base, a middle portion of the first rotating shaft is sleeved with the two bearings of the first rotating base, and a middle portion of the second rotating shaft is sleeved with the two bearings of the second rotating base.

Further, a protective cover is fixed to the bottom of the output shaft, a first accommodating groove and a second accommodating groove are respectively formed in positions of the protective cover corresponding to the first rotating base and the second rotating base, the first rotating base and the second rotating base are respectively embedded in the first accommodating groove and the second accommodating groove, through holes are formed in bottoms of the first accommodating groove and the second accommodating groove, and the bottoms of the first rotating shaft and the second rotating shaft respectively pass through the corresponding through holes and extend out.

Further, a shaft sleeve is embedded in the middle of the rotating rod, a third accommodating groove is formed in a position of the protective cover corresponding to the shaft sleeve, a bottom of the shaft sleeve is embedded in the third accommodating groove, a mounting hole is formed in a bottom of the third accommodating groove, and the bottom of the output shaft sequentially passes downwards through the shaft sleeve and the mounting hole and is fixed by means of a nut.

The dough mixer comprises the double-hook dough kneading structure.

The present invention has the beneficial effects as follows: according to the double-hook dough kneading structure in the present invention, the output shaft is used to directly drive the rotating rod to rotate, so that a sun gear at the center is omitted, and the accessory cost is reduced. In addition, the autorotation speeds of the two dough kneading hooks can be changed by adjusting the tooth numbers of the two planetary gears, the mixing effect is better, the structure is simple, and the double-hook dough kneading structure is convenient to use.

The dough mixer in the present invention has the good mixing effect by using the double-hook dough kneading structure.

### BRIEF DESCRIPTION OF DRAWINGS

FIG. 1 is a three-dimensional view of the present invention.

FIG. 2 is a three-dimensional exploded view of the present invention.

Reference numerals: output shaft 1, rotating rod 2, first rotating base 21, second rotating base 22, shaft sleeve 23, first rotating shaft 3, second rotating shaft 4, first dough kneading hook 5, first connection portion 51, first mixing portion 52, second dough kneading hook 6, second connection portion 61, second mixing portion 62, internally-toothed ring 7, first planetary gear 81, second planetary gear 82, protective cover 9, first accommodating groove 91, second accommodating groove 92, and third accommodating groove 93.

### DETAILED DESCRIPTION OF THE EMBODIMENTS

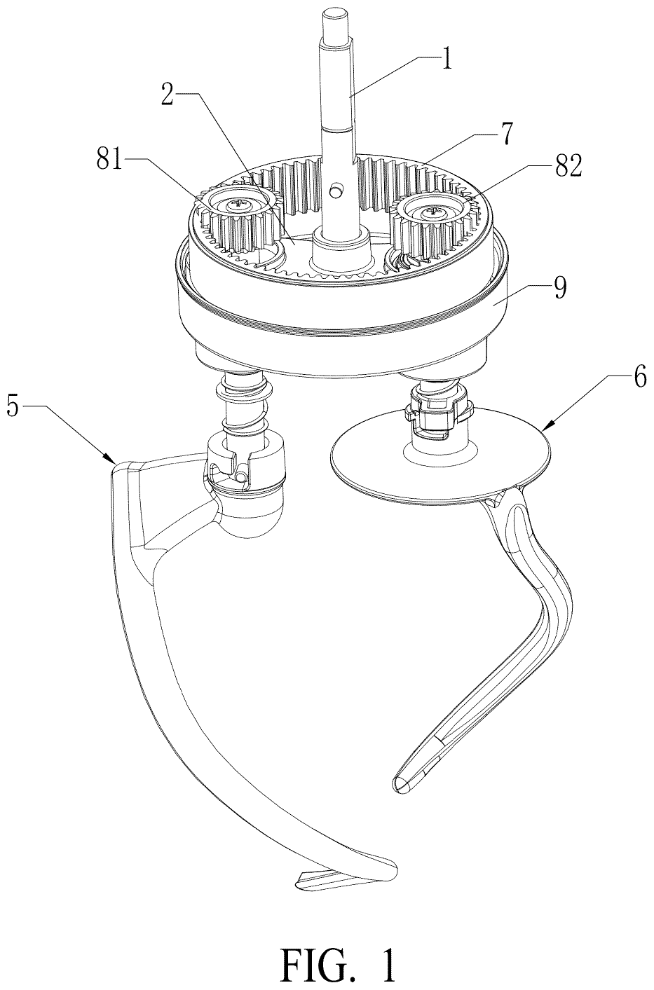

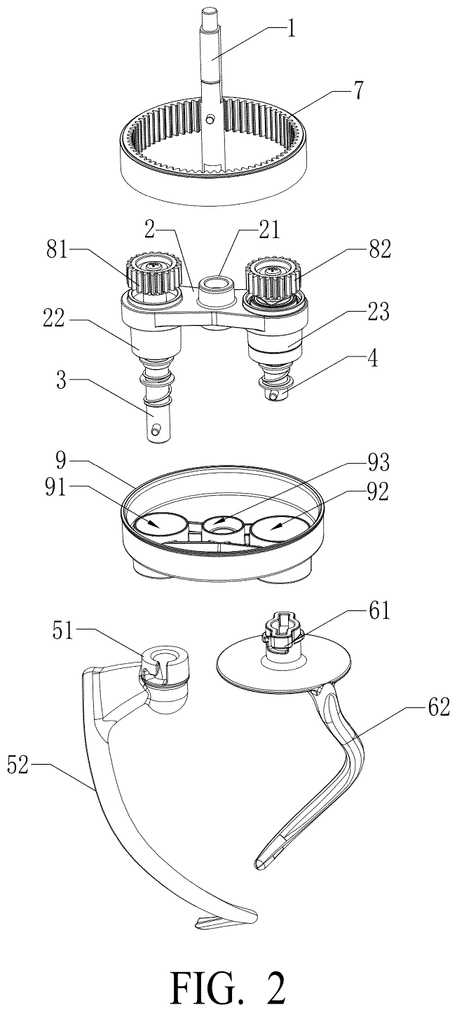

In order to facilitate understanding of a person skilled in the art, the present invention is further explained below in conjunction with embodiments and FIGS. 1-2, and the content mentioned in implementation manners is not limitations on the present invention.

As shown in FIGS. 1-2, a double-hook dough kneading structure includes an output shaft 1, a rotating rod 2 with a center perpendicularly fixed to a bottom of the output shaft 1, a first rotating shaft 3 rotationally connected to one end of the rotating rod 2, a second rotating shaft 4 rotationally connected to the other end of the rotating rod 2, a first dough kneading hook 5 detachably connected to a bottom of the first rotating shaft 3, a second dough kneading hook 6 detachably connected to a bottom of the second rotating shaft 4, an internally-toothed ring 7 fixed to an outer side of the output shaft 1, a first planetary gear 81 fixed to a top of the first rotating shaft, and a second planetary gear 82 fixed to a top of the second rotating shaft 4, where the first planetary gear 81 and the second planetary gear 82 are respectively engaged with an inner side of the internally-toothed ring 7.

According to the double-hook dough kneading structure in the present invention, the output shaft 1 is used to directly drive the rotating rod 2 to rotate, so that a sun gear at the center is omitted, and the accessory cost is reduced. In addition, the autorotation speeds of the two dough kneading hooks can be changed by adjusting the tooth numbers of the two planetary gears, the mixing effect is better, the structure is simple, and the double-hook dough kneading structure is convenient to use.

In this embodiment, the first dough kneading hook 5 includes a first connection portion 51 detachably connected to the bottom of the first rotating shaft 3 and a first mixing portion 52 fixed to a bottom of the first connection portion 51, and the first mixing portion 52 is of a single-spiral structure. The second dough kneading hook 6 includes a second connection portion 61 detachably connected to the bottom of the second rotating shaft 4 and a second mixing portion 62 fixed to a bottom of the second connection portion 61, and the second mixing portion 62 is of a single-spiral structure. The size of the first dough kneading hook 5 is greater than the size of the second dough kneading hook 6. The above structures are suitable for kneading dough, that is, mixing and kneading flour, and the arrangement of the single-spiral structures eliminates the common defects of long mixing time, residual flour after mixing and low mixing gluten production of existing mixing hooks.

In this embodiment, a first rotating base 21 is fixed to a bottom of one end of the rotating rod 2, a second rotating base 22 is fixed to a bottom of the other end of the rotating rod 2, the first rotating shaft 3 is rotationally connected into the first rotating base 21, and the second rotating shaft 4 is rotationally connected into the second rotating base 22. The arrangement of the above structures facilitates mounting of the first rotating shaft 3 and the second rotating shaft 4.

In this embodiment, bearings (not shown) are embedded in tops and bottoms of the first rotating base 21 and the second rotating base 22, a middle portion of the first rotating shaft 3 is sleeved with the two bearings of the first rotating base 21, and a middle portion of the second rotating shaft 4 is sleeved with the two bearings of the second rotating base 22. The arrangement of the above structures facilitates rotation of the first rotating shaft 3 and the second rotating shaft 4.

In this embodiment, a protective cover 9 is fixed to the bottom of the output shaft 1, a first accommodating groove 91 and a second accommodating groove 92 are respectively formed in positions of the protective cover 9 corresponding to the first rotating base 21 and the second rotating base 22, the first rotating base 21 and the second rotating base 22 are respectively embedded in the first accommodating groove 91 and the second accommodating groove 92, through holes are formed in bottoms of the first accommodating groove 91 and the second accommodating groove 92, and the bottoms of the first rotating shaft 3 and the second rotating shaft 4 respectively pass through the corresponding through holes and extend out. The arrangement of the above structures is used to protect gear structures and can also prevent impurities from falling into a mixing pot.

In this embodiment, a shaft sleeve 23 is embedded in the middle of the rotating rod 2, a third accommodating groove 93 is formed in a position of the protective cover 9 corresponding to the shaft sleeve 23, a bottom of the shaft sleeve 23 is embedded in the third accommodating groove 93, a mounting hole is formed in a bottom of the third accommodating groove 93, and the bottom of the output shaft 1 sequentially passes downwards through the shaft sleeve 23 and the mounting hole and is fixed by means of a nut. The arrangement of the above structures facilitates mounting and dismounting of the rotating rod 2 and the protective cover 9. Specifically, edge grooves are formed in two sides of the bottom of the output shaft 1, clamping blocks are fixed to positions of two sides in the shaft sleeve 23 corresponding to the two edge grooves, and the edges grooves on two sides of the bottom of the output shaft 1 are clamped between the two clamping blocks in the shaft sleeve 23, thereby preventing the rotating rod 2 from loosening during mixing. The structures are common general knowledge in the art, and are not detailed here.

The dough mixer includes the double-hook dough kneading structure. The dough mixer in the present invention has the good mixing effect by using the double-hook dough kneading structure.

The above embodiment is a preferred implementation solution of the present invention. In addition to this embodiment, the present invention can also be achieved in other manners, and any obvious substitution should fall within the scope of protection of the present invention without departing from the concept of the present invention.

What is claimed is:

1. A double-hook dough kneading structure, comprising an output shaft, a rotating rod with a center perpendicularly fixed to a bottom of the output shaft, a first rotating shaft rotationally connected to one end of the rotating rod, a second rotating shaft rotationally connected to the other end of the rotating rod, a first dough kneading hook detachably connected to a bottom of the first rotating shaft, a second dough kneading hook detachably connected to a bottom of the second rotating shaft, an internally-toothed ring fixed to an outer side of the output shaft, a first planetary gear fixed to a top of the first rotating shaft, and a second planetary gear fixed to a top of the second rotating shaft, wherein the first planetary gear and the second planetary gear are respectively engaged with an inner side of the internally-toothed ring; and the size of the first dough kneading hook is greater than the size of the second dough kneading hook.

2. The double-hook dough kneading structure according to claim 1, wherein the first dough kneading hook comprises a first connection portion detachably connected to the bottom of the first rotating shaft and a first mixing portion fixed to a bottom of the first connection portion, and the first mixing portion is of a single-spiral structure.

3. The double-hook dough kneading structure according to claim 1, wherein the second dough kneading hook comprises a second connection portion detachably connected to the bottom of the second rotating shaft and a second mixing portion fixed to a bottom of the second connection portion, and the second mixing portion is of a single-spiral structure.

4. The double-hook dough kneading structure according to claim 1, wherein a first rotating base is fixed to a bottom of one end of the rotating rod, a second rotating base is fixed to a bottom of the other end of the rotating rod, the first rotating shaft is rotationally connected into the first rotating base, and the second rotating shaft is rotationally connected into the second rotating base.

5. The double-hook dough kneading structure according to claim 4, wherein bearings are embedded in tops and bottoms of the first rotating base and the second rotating base, a middle portion of the first rotating shaft is sleeved with the two bearings of the first rotating base, and a middle portion of the second rotating shaft is sleeved with the two bearings of the second rotating base.

6. The double-hook dough kneading structure according to claim 4, wherein a protective cover is fixed to the bottom of the output shaft, a first accommodating groove and a second accommodating groove are respectively formed in positions of the protective cover corresponding to the first rotating base and the second rotating base, the first rotating base and the second rotating base are respectively embedded in the first accommodating groove and the second accommodating groove, through holes are formed in bottoms of the first accommodating groove and the second accommodating groove, and the bottoms of the first rotating shaft and the second rotating shaft respectively pass through the corresponding through holes and extend out.

7. The double-hook dough kneading structure according to claim 6, wherein a shaft sleeve is embedded in the middle of the rotating rod, a third accommodating groove is formed in a position of the protective cover corresponding to the shaft sleeve, a bottom of the shaft sleeve is embedded in the third accommodating groove, a mounting hole is formed in a bottom of the third accommodating groove, and the bottom of the output shaft sequentially passes downwards through the shaft sleeve and the mounting hole and is fixed by means of a nut.

8. A dough mixer, comprising the double-hook dough kneading structure according claim 1.
